(19) United States
(12) Patent Application Publication
(10) Pub. No.: US 2001/0021918 A1
(43) Pub. Date: Sep. 13, 2001

(54) Method and system for subscribing to network services

(76) Inventor: Keiichi Minami, Tokyo (JP)

Correspondence Address: McGuireWoods, Tysons Corner, 1750 Tysons Boulevard, Suite 1800, McLean, VA, 22102-3915, US

(21) Appl. No.: 09/801,634

(22) Filed: Mar. 9, 2001

(30) Foreign Application Priority Data
Mar. 13, 2000 (JP) 069367/2000

(51) Int. Cl. G06F 17/60

(52) U.S. Cl. 705/26

(57) ABSTRACT

A solution company acts for a customer, that is, the company purchases goods required to subscribe to a network service and go through procedures for subscribing to the service. Further, the solution company collects a predetermined charge (a commission charge) from an equipment manufacturer, a software distributor, a network carrier, and a network service provider, and returns part of the charge to the customer. It is thereby possible for the customer to reduce a burden imposed on the customer in the purchase and subscription procedures. In such a network service subscribing method and system, the customer subscribes to the network service at a low cost and in an easy way.

### BACKGROUND OF THE INVENTION

The present invention relates to a method and system for subscribing to network services. In particular, the invention relates to a method and system in which a customer can subscribe to network services at a low cost and in an easy way.

1. Description of the Prior Art

The Internet is known as a network service where a plurality of information terminals can exchange information. In recent years, subscribers to the Internet are increasing in number.

In order to enjoy such network services, it is necessary for the customer to purchase equipment such as a personal computer, a modem, and a PDA (Personal Data Assistant) as a portable information terminal, and software such as a browser used for connecting to a network. The customer should also subscribe to a telephone line such as an ISDN (Integrated Services Digital Network) line and to a provider such as an Internet service provider. Under such circumstances, the customer should make arrangements individually to purchase the equipment and software, and to subscribe to the telephone line and the Internet service provider.

However, distributors which offer the equipment and software, a telephone company, and the Internet service provider aim to increase volume of sales or the number of subscribers, and at the same time to reduce sales expense and the like. For that purpose, the distributors, companies, and providers are generally in the hope that they do business with an institutional customer (such as a company) to get quite a large quantity of orders, rather than with an individual client. Hence, a heavy burden is especially imposed on the individual client for the purchase of forth. Furthermore, the individual client individually buys the equipment, and subscribes to a telephone line and so forth, resulting in taking a long time. As is apparent from the foregoing, the individual client has difficulties in subscribing to the network services in view of cost and time.

### SUMMARY OF THE INVENTION

In order to overcome the foregoing problems, it is an object of the present invention to provide a network service subscribing method and system which make it possible to reduce the burden imposed on a customer when he or she subscribes to a network service.

A method for subscribing to network services provided over a communication network according to the present invention, comprising the steps of accepting in block by a service reception company purchase of goods and procedures required when a customer subscribes to said network services; purchasing, by said service reception company, said goods from a goods distributor and doing procedures for subscribing to said network services provided by a service supplier; and distributing said goods to the customer by said goods distributor and starting providing said network services by said service supplier.

In the method for subscribing to network services according to the present invention, the service reception company collects a predetermined charge from said goods distributor and said service supplier, and returns part of said charge to the customer. In the method, the service reception company also serves as the goods distributor and service supplier.

According to a network service subscribing system of the present invention, said service being provided over a communication network, and the system comprising: a service reception company for accepting in block purchase of goods and procedures required when a customer subscribes to said network service; a first means for causing said service reception company to purchase said goods from a goods distributor and do procedures for subscribing to said network services provided by a service supplier; a second means for causing said goods distributor to distribute said goods to the customer; and a third means for causing said service supplier to start providing said network services.

### BRIEF DESCRIPTION OF THE DRAWINGS

FIG. 1 is an explanatory view showing an embodiment of the present invention; and

FIG. 2 is an explanatory view of monthly charges that a customer bears.

### DESCRIPTION OF THE PREFERRED EMBODIMENTS

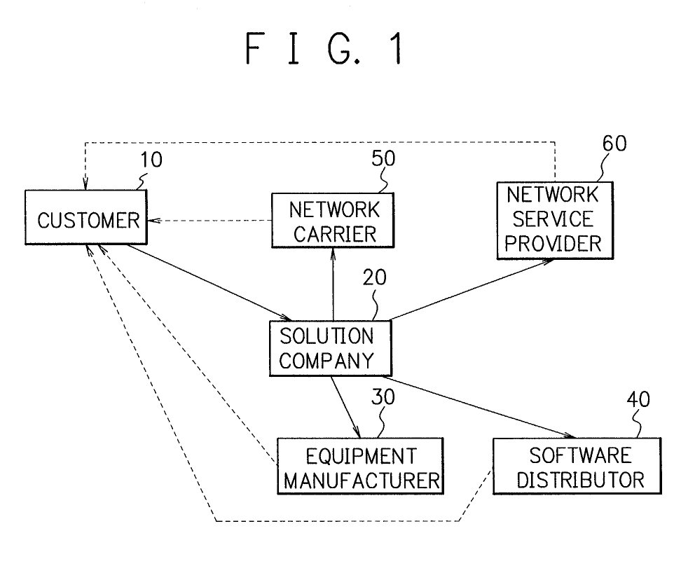

A description will now be given of a preferred embodiment of the present invention. FIG. 1 is an explanatory view according to an embodiment of the present invention.

A customer 10 and a solution company 20 exchange information through, for example, a communication network such as a telephone line, or via a mail. Further, the solution company 20 also exchanges information with an equipment manufacturer 30, a software distributor 40, a network carrier 50, and a network service provider 60 through, for example, a communication network.

When the solution company 20 receives an order from the customer 10, the solution company 20 places an order as required, with the equipment manufacturer 30, the software distributor 40, the network carrier 50, and the network service provider 60. In the present embodiment, the solution company 20 is a service reception company, the equipment manufacturer 30 and the software distributor 40 act as a goods distributor, and the network carrier 50 and the network service provider 60 are a service provider. In the following discussion, the equipment manufacturer 30, the software distributor 40, the network carrier 50, and the network service provider 60 will collectively be called a service supplier. The service supplier provides in response to reception of the order, the customer 10 with the service ordered.

The equipment manufacturer 30 is a manufacturer that manufactures equipment such as a personal computer and a modem required for connection to a network. The software distributor 40 sells software such as an operating system (OS) and a browser used for connection to a network. The network carrier 50 is a carrier (a telephone company) that administers and operates a telephone network such as an ISDN. The network service provider 60 is a service provider who administers and operates a communication network such as the Internet. The network service provider 60 is, for example, an Internet service provider.

A description will now be given of the operation associated with the present invention. The solution company 20 provides the customer 10 with a purchasing information on products or the like through an advertising and so forth. The customer 10 makes the solution company 20 a request for purchasing the equipment and the software required for connection to the network, and a request for procedures for subscribing to a telephone line, the Internet service provider and so forth.

When the solution company 20 receives an order from the customer 10, the company places an order regarding a required service with the service supplier. The order placement is done upon reception of an order from the customer 10, or according to the number of goods in stock in the solution company 20. In the present embodiment, the solution company 20 may be a company with a physical distribution system capable of securing a stock of commodities such as equipment.

For example, the solution company 20 requests an order to the equipment manufacturer 30 or the software distributor 40 in response to an order from the customer 10, or when the company 20 has a small stock of the equipment or the software. The order will then be sent to the network carrier 50 and the network service provider 60 in response to reception of an order from the customer 10. If the solution company 20 can previously ensure from the network carrier 50 the required number of telephone subscription rights, the order may be sent at the time when the number of these subscription rights becomes small. Similarly, if the solution company 20 can ensure from the network service provider 60 the required number of rights to subscribe to the network service, the order may be sent when the number of the subscription rights becomes small.

Upon reception of an order, the equipment manufacturer 30 delivers the ordered equipment to the customer 10 directly or through the solution company 20. Delivery of equipment is made by means of a delivery on consignment by for example, a package-delivery service company, or by means of a physical distribution system owned by the manufacturer. Similarly, when the software distributor 40 receives an order, the distributor delivers the ordered software to the customer 10 directly or through the solution company 20.

It should be noted that the solution company 20 may install the software purchased from the software distributor 40 on the equipment bought from the equipment manufacturer 30, and deliver the equipment to the customer 10. Thus, it is possible for the customer 10 to save labor to install the required software. As a result, the customer 10 can receive the network service immediately after the delivery.

Alternatively, the solution company 20 may open a Web site to build a Uniform Resource Locater (URL) thereof into software (a browser) purchased from the software distributor 40, and may deliver the software to the customer 10. As a result, even if any trouble occurs in the connection to the network, the customer 10 can have access to a home page to receive a proper advice from the solution company 20.

The solution company 20 may lease the equipment, the software and so forth to the customer 10. The solution company 20 may also temporarily pay a purchase price for the customer 10, and collect the price from the customer 10 by installments. It is thereby possible for the customer 10 to reduce an initial investment required for subscription to the network service. Alternatively, the solution company 20 may provide the customer 10 with instructions for the operation of the equipment or the like. In this scenario, the training may be provided with the customer 10 through communications over the telephone, or by exchange through the use of e-mails, or by dispatching an instructor.

Upon reception of an order, the network carrier 50 allows the customer 10 to subscribe to the network. Similarly, the network service provider 60 allows the customer 10 to subscribe to the network service. Allowance may be posted to the customer 10 directly or through the solution company 20.

As set forth above, without any special sales activity, the service supplier can receive continuously or intermittently a large order from the solution company 20. This results in the reduction of sale expenses with ease. Therefore, in exchange for the large order, the solution company 20 can receive a commission charge earned on the sales from the service supplier. Part of the commission charge is then returned to the customer.

More specifically, if an ordinary price of the equipment is twenty thousand yen, and the solution company 20 receives five thousand yen as a commission charge from the equipment manufacturer 30, the solution company 20 can purchase the equipment at a reduced price of fifteen thousand yen. Assuming that the solution company 20 returns part of the commission charge (for example, three thousand yen) to the customer 10. In this case, the solution company 20 offers the equipment to the customer 10 at a price of eighteen thousand yen. Thus, the customer 10 can purchase the equipment at a price lower than an ordinary price by two thousand yen. The difference obtained by subtracting the amount returned to the customer 10 from the commission charge that the solution company 20 has collected from the equipment manufacturer 30, corresponds to a commission charge which should be charged to the customer 10. That is, in this case, the customer 10 bears a commission charge of two thousand yen, which is obtained by the following calculation:

5000−3000=¥2000

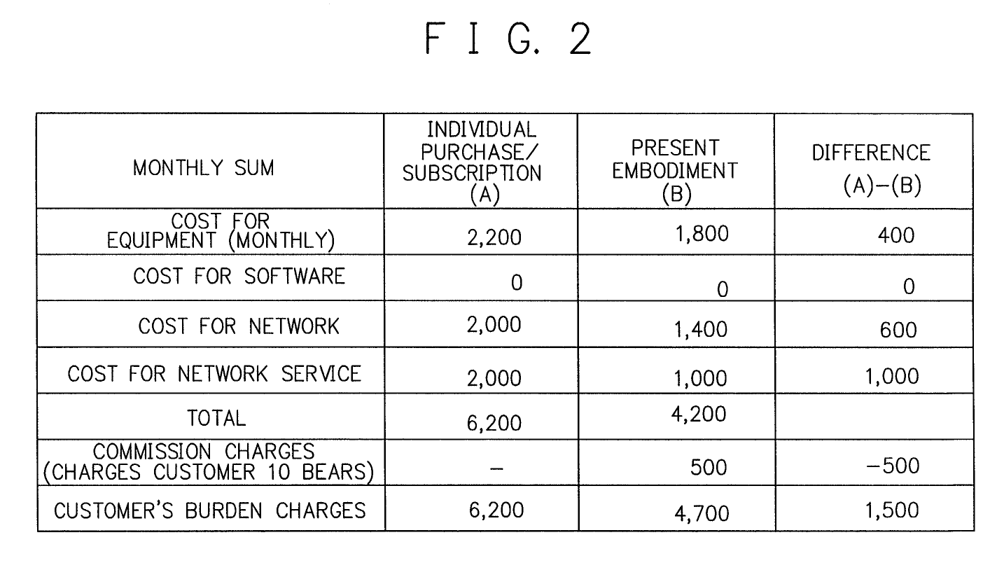

FIG. 2 is an explanatory view of monthly charges that the customer 10 bears for subscription to a network service. As shown in FIG. 2, a monthly cost for the equipment according to the present embodiment is lower than that in the conventional case where the equipment is individually purchased and subscription is individually made. The same is true for the cost for software, the cost for a network, and the cost for a network service. In the present embodiment, the customer 10 bears a commission charge of five hundred yen, however, the total amount that the customer 10 should bear is lower than that in the conventional case where the equipment is individually purchased and subscription is individually made. Accordingly, without high initial investments, the customer 10 can subscribe to the network service. Furthermore, the customer 10 can purchase the required equipment and go through procedures for subscribing to a telephone line together or in block, through the solution company 20.

In the above embodiment, the solution company 20, the equipment manufacturer 30, the software distributor 40, the network carrier 50, and the network service provider 60 are described as an independent corporation (a company). However, the solution company 20 may serve as the equipment manufacturer 30, the software distributor 40, the network carrier 50, and the network service provider 60.

For example, the solution company 20, the equipment manufacturer 30, the software distributor 40, and the network service provider 60 may be respective business institutions in the same corporation. In this case, vertical integration can be done with respect to these respective business institutions so that efficient evolution of business can be expected. It is therefore possible to increase the number of subscribers to the network service while selling equipment such as personal computers.

As set forth above, according to the present embodiment, the solution company 20 when accepting services, can receive a commission charge from the service suppliers such as the equipment manufacturer 30, and returns part of the commission charge to the customer 10. This enables the customer 10 to purchase the equipment required to subscribe to a network service, and to go through procedures for subscribing to a service, at a low price. The customer 10 can also finish purchase of goods and go through procedures associated with a subscription at a time, through the solution company 20. In addition, the solution company 20 can increase profits by collecting the commission charge.

Further, the solution company 20 can serve as the equipment manufacturer 30, the software distributor 40, the network carrier 50, and the network service provider 60 as described above, thus resulting in efficient evolution of business as a result of vertical integration of these business institutions.

According to the present invention, the service reception company acts for the customer, that is, the service reception company purchase the goods required to subscribe to a network service, and go through procedures for subscribing to a service. The service reception company sends an order to a goods distributor and does the procedures to subscribe to a service supplier as required. The goods distributor and service supplier can therefore receive a large order without any special sales activity, thus reducing sale expenses. Furthermore, the service reception company collects a predetermined charge from the goods distributor and service supplier, and returns part of the charge to the customer. It is thereby possible for the customer to reduce a burden imposed on the customer when purchasing the goods and subscribing to a service. The customer 10 can also purchase goods and go through procedures for subscribing to a service together, through the service reception company. In addition, the service reception company can chase a profit by collecting the predetermined charge.

The service reception company can serve as the goods distributor and service supplier, which enables vertical integration of the business institutions to bring about efficient evolution of business. For example, it is possible for one company to sell software such as a browser, and to increase the number of subscribers to the Internet service provider, while selling equipment such as a personal computer and a modem.

What is claimed is:

1. A method for subscribing to network services provided over a communication network, comprising the steps of:
accepting in block by a service reception company purchase of goods and procedures required when a customer subscribes to said network services;
purchasing, by said service reception company, said goods from a goods distributor and doing procedures for subscribing to said network services provided by a service supplier; and
distributing said goods to the customer by said goods distributor and starting providing said network services by said service supplier.

2. A method for subscribing to network services according to claim 1, wherein said service reception company collects a predetermined charge from said goods distributor and said service supplier, and returns part of said charge to the customer.

3. A method for subscribing to network services according to claim 1, wherein said required goods include equipment or software that is required for subscribing to said network services, and said required procedures include procedures for subscribing to a telephone line or a network provider.

4. A method for subscribing to network services according to claim 2, wherein said service reception company serves as said goods distributor and service supplier.

5. A network service subscribing system, said service being provided over a communication network, comprising:
a service reception company for accepting in block purchase of goods and procedures required when a customer subscribes to said network service;
a first means for causing said service reception company to purchase said goods from a goods distributor and do procedures for subscribing to said network services provided by a service supplier;
a second means for causing said goods distributor to distribute said goods to the customer; and
a third means for causing said service supplier to start providing said network services.

6. A network service subscribing system according to claim 5, wherein said service reception company collects a predetermined charge from said goods distributor and said service supplier, and returns part of said charge to the customer.

7. A network service subscribing system according to claim 6, wherein said service reception company serves as said goods distributor and service supplier.
